(19) United States
(12) Patent Application Publication
(10) Pub. No.: US 2004/0044123 A1
(43) Pub. Date: Mar. 4, 2004

(54) Heat resistant resin bonded grindstone

(75) Inventors: Yoshiyuki Satow, Kanagawa (JP); Tatsuo Tsumiyama, Ube-shi (JP)

Correspondence Address: NIXON PEABODY, LLP, 401 9TH STREET, NW, SUITE 900, WASINGTON, DC, 20004-2128, US

(73) Assignees: Ube Industries, Ltd., Ube-shi (JP); Shin-Nissan Diamond Tools Mfg. Co., Ltd., Yokohama-shi (JP)

(21) Appl. No.: 10/650,821

(22) Filed: Aug. 29, 2003

(30) Foreign Application Priority Data
Aug. 30, 2002 (JP) 2002-254798

(51) Int. Cl. C08L 77/00

(52) U.S. Cl. 524/606

(57) ABSTRACT

A heat resistant resin bonded grindstone is prepared by heating under pressure a molded composition comprising 20 to 50 vol. % of a polyimide resin powder, 50 to 70 vol. % of a metal powder, and 10 to 30 vol. % of a diamond powder, so that the diamond powder can be dispersed in and supported by a binder phase comprising the polyimide resin powder and the metal powder, in which the polyimide resin powder has been produced from a diamine compound comprising p-phenylenediamine and a mixture of 85 to 97 mol. % of 3,3′,4,4′-biphenyltetracarboxylic acid or its dianhydride and 15 to 3 mol. % of 2,3,3′,4′-biphenyltetracarboxylic acid or its dianhydride.

### FIELD OF THE INVENTION

The present invention relates to a heat resistant resin bonded grindstone (or grindwheel) using a heat resistant polyimide resin binder and a grinding tool having the heat resistant resin bonded grindstone.

### BACKGROUND OF THE INVENTION

Heretofore, a phenol resin is employed as a binder resin of a resin bonded grindstone of a diamond wheel. The conventional diamond wheel, however, has a problem in that it is not favorably employable in severe grinding works such as grinding works producing a large amount of heat, because the phenol resin binder is apt to deteriorate by the heat resulting in lowering of its binder function. In order to improve heat resistance of the binder resin of the resin bonded wheel, studies for utilizing a heat resistant polyimide as the binder resin have been made. In the initial stage, a resin bonded grindstone utilizing a polyimide resin which is prepared from pyrromellitic dianhydride and 4,4-diaminodiphenyl ether. This polyimide is advantageous in its molding performance, but is disadvantageous in that its heat resistance and mechanical endurance are still unsatisfactory.

Japanese Patent Publication 63-62349 describes a heat resistant resin bonded grindstone that employs a polyimide resin binder prepared using a biphenyltetracarboxylic acid compound comprising 3,3′,4,4′-biphenyltetracarboxylic acid or its dianhydride. However, this heat resistant resin bonded grindstone has a problem in that it shows a disadvantageously high grinding resistance.

It has been further known a metal bonded grindstone that utilizes a metal binder and shows a high heat resistance and mechanical strength. The metal bonded grindstone is known to show a satisfactorily low grinding resistance. However, the metal bonded grindstone has a problem in that its grinding sharpness is lower than the grinding sharpness given by the resin bonded grindstone.

### SUMMARY OF THE INVENTION

It is an object of the present invention to provide a resin bonded grindstone which shows not only a high heat resistance and mechanical strength but also a high grinding sharpness.

The present invention resides in a heat resistant resin bonded grindstone prepared by heating under pressure a molded composition comprising 20 to 50 vol. % of a polyimide resin powder, 50 to 70 vol. % of a metal powder, and 10 to 30 vol. % of a diamond powder, whereby the diamond powder becomes dispersed in and supported by a binder phase comprising the polyimide resin powder and the metal powder, said polyimide resin powder having been produced from a diamine compound comprising p-phenylenediamine and a mixture of 85 to 97 mol. % of 3,3′,4,4′-biphenyltetracarboxylic acid or a dianhydride thereof and 15 to 3 mol. % of 2,3,3′,4′-biphenyltetracarboxylic acid or a dianhydride thereof.

The present invention further resides in a heat resistant resin bonded grindstone prepared by heating under pressure a molded composition comprising 20 to 50 vol. % of a polyimide resin powder, 50 to 70 vol. % of a metal powder, and 10 to 30 vol. % of a diamond powder, whereby the diamond powder becomes dispersed in and supported by a binder phase comprising the polyimide resin powder and the metal powder, said polyimide resin powder having a surface layer comprising a polyimide resin that has been produced from a diamine compound comprising p-phenylenediamine and 2,3,3′1,4′-biphenyltetracarboxylic acid or a dianhydride thereof.

The heat resistant resin bonded grindstone of the invention can be prepared by heating a molded composition comprising 20 to 50 vol. % of one or both of the above-mentioned polyimide resin powders, 50 to 70 vol. % of a metal powder, and 10 to 30 vol. % of a diamond powder at a temperature of 450 to 530° C. and a pressure of 500 to 5,000 kg/cm², whereby the diamond powder becomes dispersed and supported in a binder phase comprising the polyimide resin powder and the metal powder.

The invention further resides in a grinding tool comprising one of the aforementioned heat resistant resin bonded grindstones attached to a substrate.

Preferred embodiments of the invention are described below:

(1) The heating is performed at a temperature of not lower than 450° C.

(2) The metal powder is a powder of aluminum, copper, nickel, or an alloy comprising at least one of aluminum, copper, and nickel.

(3) The metal powder is a powder of an alloy containing copper.

(3) The metal powder is a powder of an alloy of copper and tin, namely, a bronze powder.

(4) The molded composition comprises 20 to 45 vol. % of a polyimide resin powder, 55 to 70 vol. % of a metal powder, and 10 to 30 vol. % of a diamond powder.

(5) The polyimide resin powder comprises a core portion comprising a polyimide resin that has been produced from a diamine compound comprising p-phenylenediamine and 3,3′,4,4′-biphenyltetracarboxylic acid or a dianhydride thereof and a surface layer comprising a polyimide resin that has been produced from a diamine compound comprising p-phenylenediamine and 2,3,3′,4′-biphenyltetracarboxylic acid or a dianhydride thereof.

### BRIEF DESCRIPTION OF THE DRAWINGS

FIG. 1 illustrates a grinding tool of a cup type which is composed of a substrate and a heat resistant resin bonded grindstone of the invention attached to the substrate.

FIG. 2 illustrates a grinding tool of a straight type which is composed of a substrate and a heat resistant resin bonded grindstone of the invention attached to the substrate.

FIG. 3 is a graph indicating a variation of anti-wear performance which is observed on-heated products of composition comprising a polyimide powder and a copper-tin alloy powder at varying volume ratios.

### DETAILED DESCRIPTION OF THE INVENTION

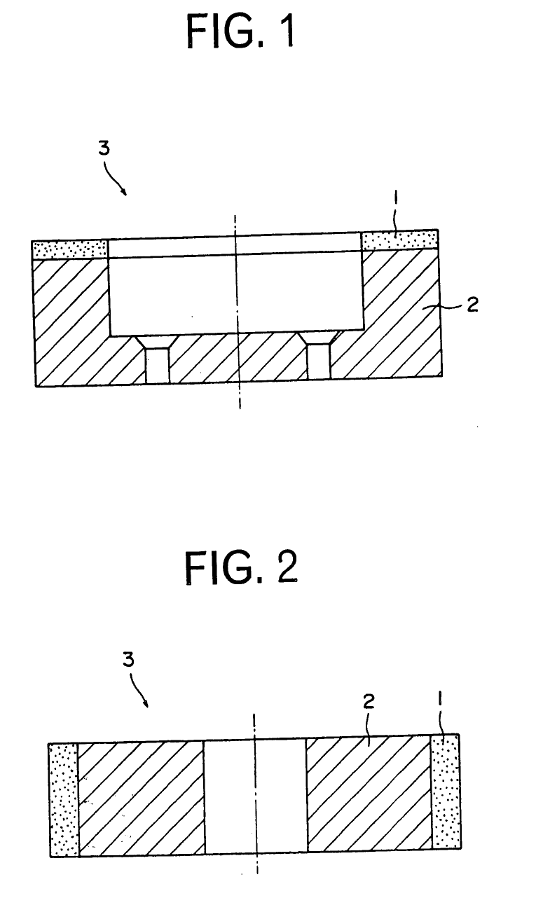

As is illustrated in FIG. 1 and FIG. 2, the heat resistant resin bonded grindstone 1 of the invention can be employed in the form of a grinding tool 3 composed of the grindstone 1 and a substrate. The grinding tool of FIG. 1 is named a cup type tool, and the grinding tool of FIG. 2 is named a straight type tool.

The grindstone is prepared by heating under pressure a molded composition comprising 20 to 50 vol. % of a specific polyimide resin powder, 50 to 70 vol. % of a metal powder, and 10 to 30 vol. % of a diamond powder, whereby the diamond powder becomes dispersed in and supported by a binder phase comprising the polyimide resin powder and the metal powder.

The polyimide resin powder can be one of the following polyimide resin powders:

(1) a polyimide resin powder which has been produced from a diamine compound comprising p-phenylenediamine and a mixture of 85 to 97 mol. % of 3,3′,4,4′biphenyltetracarboxylic acid or a dianhydride thereof and 15 to 3 mol. % of 2,3,3′,4′-biphenyltetracarboxylic acid or a dianhydride thereof;

(2) a polyimide resin powder which has a surface layer comprising a polyimide resin that has been produced from a diamine compound comprising p-phenylenediamine and 2,3,3′,4′-biphenyltetracarboxylic acid or a dianhydride thereof and which preferably has a core portion comprising a polyimide resin that has been produced from a diamine compound comprising p-phenylenediamine and 3,3′,4,4′-biphenyltetracarboxylic acid or a dianhydride thereof.

The polyimide resin powder employed in the invention can be prepared by a method described in Japanese Patent Provisional Publication 2000-129001. One typical method is described in the under-mentioned working example.

The polyimide resin may further contain a small amount of a unit of other tetracarboxylic compound and a small amount of a unit of other diamine compound. Some of these other compounds are described in Japanese Patent Provisional Publication 2000-129001.

The polyimide resin powder employed in the invention preferably has a mean particle size in the range of 5 to 15 μm.

The metal powder preferably has a mean particle size in the range of 5 to 20 μm.

The diamond powder can be selected from those that are known to be employable for manufacture of a resin bonded grindstone.

The grindstone can be manufactured by molding a composition of the polyimide resin powder, metal powder, and diamond powder by means of a known mold. Otherwise, the composition can be heated on a substrate under pressure to give directly a grinding tool. Alternatively, a separately prepared grindstone layer can be attached to a substrate using a heat resistant adhesive.

The present invention is further described by the following examples.

### EXAMPLES

[Preparation of Polyimide Resin Powder]

In a four-necked flask equipped with thermometer, stirrer, nitrogen gas-inlet, and water separator were placed under nitrogen gas conditions 408.03 g of dry 3,3′,4,4′-biphenyltetracarboxylic dianhydride, 30.71 g of 2,3,3′,4′-biphenyltetracarboxylic dianhydride, and 2,930 g of dry N-methyl-2-pyrrolidone. The mixture was heated under stirring to reach 50° C. to give a homogeneous solution. To the solution was added 161.26 g of p-phenylenediamine. After lapse of 0.5 hour, the resulting mixture was heated to 190° C. for 1.5 hours, and then kept at 190° C. for 3 hours, for performing a reaction. When the mixture reached 1610C, a polyimide resin powder precipitated. Water produced in the course of heating was continuously removed from the reaction mixture. After the heating was complete, a yellow polyimide resin powder dispersed in N-methyl-2-pyrrolidone was collected by filtration, washed three times in three portions of boiled water (one hour for one washing procedure), dried at an atmospheric pressure by using hot air (heated to 130° C.), dried at 2000C under reduced pressure, to give a polyimide resin powder.

According to transmission microscopic observation, the resulting polyimide resin powder was composed of a core portion of a crystalline polyimide resin and a surface layer of an amorphous polyimide resin. The core portion consisted essentially of a polyimide resin produced from 3,3′,4,4′-biphenyltetracarboxylic dianhydride and p-phenylenediamine, whereas the surface layer consisted essential of a polyimide resin produced from 2,3,3′,4′-biphenyltetracarboxylic dianhydride and p-phenylenediamine.

[Evaluation of Function of Metal Powder in Resin Bonded Grindstone]

Thus obtained polyimide resin powder and a copper-tin alloy powder (bronze powder containing 15 wt. % of tin) was mixed in various volume ratios and molded. The molded mixtures were heated to 450° C., to give a plurality of rigid products. The rigid products were measured in their wear resistance under the following conditions:

| Machine: | ENGIS KENT3 |
|---|---|
| Size of specimen: | φ20 mm × 10 mm |
| Abrasive paper: | Waterproof abrasive paper #320 |
| Pressure: | 300 g/cm² |
| Pressing period: | 120 min. (abrasive paper was |
| | replaced by every 20 minute |
| | period) |
| Pressing condition: | rotation at 320 rpm |
| | swaying at 16 times/min. |
| Cooling water: | tap water |

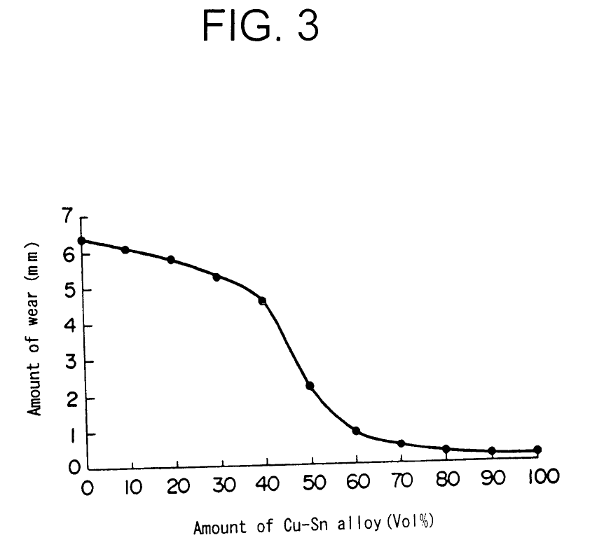

The results are graphically shown in FIG. 3. As is clear from the graph of FIG. 3, the wear resistance prominently increase when the content of the copper-tin alloy powder exceeds approx. 50 vol. %. This phenomenon was understood to derive from the fact that the rigid product is composed of a structure (matrix) of a mass of dispersed copper-tin alloy particles which are partially fused with each other.

[Evaluation of Resin Bonded Grindstone]

Forty vol. % of the above-obtained polyimide resin powder and 60 vol. % of a copper-tin alloy powder (bronze powder containing 15 wt. % of tin) were mixed. Subsequently, 75 vol. % of the resulting mixture and 25 vol. % of a diamond abrasive powder were mixed. The resulting mixture was placed in a mold and heated to 500° C. at a pressure of 2,000 kg/cm to give a grindstone of the invention (Specimen of Invention).

For comparison, the following two resin bonded grindstones were prepared:

Comparison specimen 1: prepared using as a binder resin a polyimide resin powder (secondary transition temperature: 250-380° C.) produced from 3,31,4,41-biphenyltetracarboxylic dianhydride and 4,4′-diaminodiphenyl ether;

Comparison specimen 2: prepared using a phenol resin as a binder resin.

The specimen of invention and two comparison specimens were subjected to measurement of grinding resistance and grinding ration for evaluating the grindstone performances. The measurement of grinding resistance was made in both of the tangent direction and normal direction. The results of the measurements are set forth in Table 1.

TABLE 1

| | Grinding resistance | | Grinding |
|---|---|---|---|
| Specimen | Tangential (Ft) | Normal (Fn) | ratio |
| Invention | 60 | 178 | 707 |
| Comparison 1 | 103 | 275 | 689 |
| Comparison 2 | 72 | 204 | 340 |

The results of Table 1 indicate that the specimen of Invention shows the lowest grinding resistance in both of the tangential and normal directions. This means that the grindstone of the invention shows a sharp grinding performance. Further, in view of the grinding ratio indicating that the specimen of the invention shows the highest grinding ratio, it is concluded that the grindstone of the invention shows a longer lifetime.

Thus, the resin bonded grindstone of the invention has a performance better than the conventional resin bonded grindstones in both of the grinding sharpness and lifetime.

Accordingly, it is concluded that the polyimide resin bonded grindstone of the invention shows both of grinding sharpness comparable to the conventional resin bonded grindstone and wear resistance comparable to the conventional metal bonded grindstone. Further, it is noted that the grindstone of the invention is resistant in the wear occurring at the edge portions. Furthermore, it is noted that the polyimide resin bond is highly resistant to heat produced under very severe grinding conditions. Accordingly, the polyimide resin bonded grindstone of the invention shows good grinding performances in the dry grinding works.

What is claimed is:

1. A heat resistant resin bonded grindstone prepared by heating under pressure a molded composition comprising 20 to 50 vol. % of a polyimide resin powder, 50 to 70 vol. % of a metal powder, and 10 to 30 vol. % of a diamond powder, whereby the diamond powder becomes dispersed in and supported by a binder phase comprising the polyimide resin powder and the metal powder, said polyimide resin powder having been produced from a diamine compound comprising p-phenylenediamine and a mixture of 85 to 97 mol. % of 3,3′,4,4′-biphenyltetracarboxylic acid or a dianhydride thereof and 15 to 3 mol. % of 2,3,3′,4′-biphenyltetracarboxylic acid or a dianhydride thereof.

2. The heat resistant resin bonded grindstone of claim 1, wherein the heating is performed at a temperature of not lower than 450° C.

3. The heat resistant resin bonded grindstone of claim 1, wherein the metal powder is a powder of aluminum, copper, nickel, or an alloy comprising at least one of aluminum, copper, and nickel.

4. The heat resistant resin bonded grindstone of claim 3, wherein the metal powder is a powder of an alloy of copper and tin.

5. The heat resistant resin bonded grindstone of claim 1, wherein the molded composition comprises 20 to 45 vol. % of a polyimide resin powder, 55 to 70 vol. % of a metal powder, and 10 to 30 vol. % of a diamond powder.

6. A grinding tool comprising the heat resistant resin bonded grindstone of claim 1 attached to a substrate.

7. A method for manufacturing a heat resistant resin bonded grindstone which comprises heating a molded composition comprising 20 to 50 vol. % of a polyimide resin powder, 50 to 70 vol. % of a metal powder, and 10 to 30 vol. % of a diamond powder at a temperature of 450 to 530° C. and a pressure of 500 to 5,000 kg/cm², whereby the diamond powder becomes dispersed and supported in a binder phase comprising the polyimide resin powder and the metal powder, said polyimide resin powder having been produced from a diamine compound comprising p-phenylenediamine and a mixture of 85 to 97 mol. % of 3,3′,4,4′-biphenyltetracarboxylic acid or a dianhydride thereof and 15 to 3 mol. % of 2,3,3′,4′-biphenyltetracarboxylic acid or a dianhydride thereof.

8. A heat resistant resin bonded grindstone prepared by heating under pressure a molded composition comprising 20 to 50 vol. % of a polyimide resin powder, 50 to 70 vol. % of a metal powder, and 10 to 30 vol. % of a diamond powder, whereby the diamond powder becomes dispersed in and supported by a binder phase comprising the polyimide resin powder and the metal powder, said polyimide resin powder having a surface layer comprising a polyimide resin that has been produced from a diamine compound comprising p-phenylenediamine and 2,3,3′,4′-biphenyltetracarboxylic acid or a dianhydride thereof.

9. The heat resistant resin bonded grindstone of claim 8, wherein the heating is performed at a temperature of not lower than 450° C.

10. The heat resistant resin bonded grindstone of claim 8, wherein the metal powder is a powder of aluminum, copper, nickel, or an alloy comprising at least one of aluminum, copper, and nickel.

11. The heat resistant resin bonded grindstone of claim 10, wherein the metal powder is a powder of an alloy of copper and tin.

12. The heat resistant resin bonded grindstone of claim 8, wherein the molded composition comprises 20 to 45 vol. % of a polyimide resin powder, 55 to 70 vol. % of a metal powder, and 10 to 30 vol. % of a diamond powder.

13. The heat resistant resin bonded grindstone of claim 8, wherein the polyimide resin powder comprising a core portion comprising a polyimide resin that has been produced from a diamine compound comprising p-phenylenediamine and 3,3′,4,4′-biphenyltetracarboxylic acid or a dianhydride thereof and a surface layer comprising a polyimide resin that has been produced from a diamine compound comprising p-phenylenediamine and 2,3,3′,4′-biphenyltetracarboxylic acid or a dianhydride thereof.

14. A grinding tool comprising the heat resistant resin bonded grindstone of claim 8 attached to a substrate.

15. A method for manufacturing a heat resistant resin bonded grindstone which comprises heating a molded composition comprising 20 to 50 vol. % of a polyimide resin powder, 50 to 70 vol. % of a metal powder, and 10 to 30 vol. % of a diamond powder at a temperature of 450 to 530° C. and a pressure of 500 to 5,000 kg/cm², whereby the diamond powder becomes dispersed and supported in a binder phase comprising the polyimide resin powder and the metal powder, said polyimide resin powder having a surface layer comprising a polyimide resin that has been produced from a diamine compound comprising p-phenylenediamine and 2,3,3′,4′-biphenyltetracarboxylic acid or a dianhydride thereof.
